(19) United States
(12) Patent Application Publication
(10) Pub. No.: US 2015/0113260 A1
(43) Pub. Date: Apr. 23, 2015

(54) INSTALLATION SYSTEM FOR INSTALLING GUEST OPERATING SYSTEM AND METHOD THEREOF

(71) Applicant: POWER-ALL NETWORKS LIMITED, Shatin (HK)

(72) Inventors: MENG-MING HUANG, Shenzhen (CN); JUN LV, Shenzhen (CN); YUN-JIE XU, Shenzhen (CN)

(21) Appl. No.: 14/512,606

(22) Filed: Oct. 13, 2014

(30) Foreign Application Priority Data
Oct. 18, 2013 (CN) 201310490136.0

(51) Int. Cl. G06F 9/44; G06F 9/455

(52) U.S. Cl. CPC G06F 9/4416; G06F 9/4406; G06F 9/455
USPC 713/2

(57) ABSTRACT

A method for installing a guest operating system on a virtual machine (VM) includes: providing a management interface provided for a user to input or select a command for a VM, and transmitting the command input or selected by the user to a communication module associated with the VM; starting up the VM when the command is a startup command; running a cloudboot system of the VM when the VM is starting up; and downloading an installation file from the server and executing the installation file to install the guest operating system corresponding to the installation file on the VM when the command is a download command.

### CROSS-REFERENCE TO RELATED APPLICATIONS

This application claims priority to Chinese Patent Application No. 201310490136.0 filed on Oct. 18, 2013, the contents of which are incorporated by reference herein.

1. “CLOUDBOOT SYSTEM, VIRTUAL MACHINE WITH THE CLOUDBOOT SYSTEM, AND METHOD FOR STARTING UP THE VIRTUAL MACHINE” by Huang et al., whose Attorney Docket No is US54180.

### FIELD

The present disclosure relates to cloud computing, and particularly to an installation system for installing a guest operating system to a virtual machine and a method thereof.

### BACKGROUND

A virtual machine (VM) is a software implementation of a machine that executes programs similar to a physical machine, such as a server and a personal computer. Usually, the VM is constituted in the physical machine by a corresponding virtual platform and a guest operating system for the VM can only be installed based on the corresponding virtual platform. For example, a virtual machine constituted by a XEN platform (an open source enterprise-ready server virtualization and cloud computing platform) can only install a corresponding guest operating system based on the XEN platform, and cannot install a corresponding guest operating system based on other virtual platforms, such as a Kernel-based Virtual Machine (KVM) platform.

### BRIEF DESCRIPTION OF THE DRAWINGS

Implementations of the present technology will now be described, by way of example only, with reference to the attached figures.

FIG. 1 is a block diagram of an installation system for downloading a guest operating system.

FIG. 2 is hardware environment running the installation system of FIG. 1.

FIG. 3 is a diagrammatic view of a management interface provided by a management server.

FIG. 4 is a flowchart diagram of an embodiment of a method for downloading a guest operating system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY, flash memory, and hard disk drives. The term “comprising” means “including, but not necessarily limited to”; it specifically indicates open-ended inclusion or membership in a so-described combination, group, series and the like. The connection can be such that the objects are permanently connected or releasably connected.

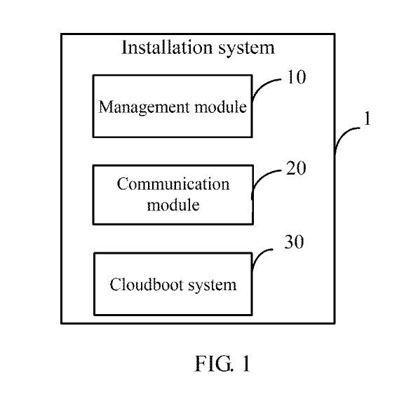

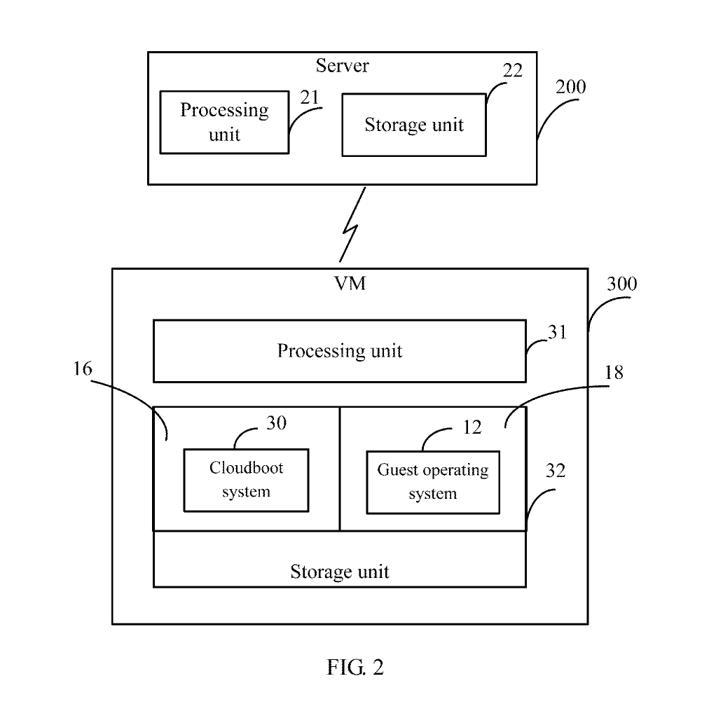

Referring to FIG. 1 and FIG. 2, an installation system 1 for downloading a guest operating system is illustrated. The installation system 1 is running in at least one server 200 and at least one virtual machine (VM) 300 as shown in FIG. 2 and is used to download an installation file of the corresponding guest operating system 12 to the VM 300 and install the guest operating system 12 on the VM 300 by executing the installation file. The VM 300 can be constituted based on any virtual platform, such as a XEN platform, a KVM platform, and the like. The guest operating system 12 can be a WINDOWS operating system, a LINUX operating system, and the like.

The server 200 includes a processing unit 21 and a storage unit 22. The VM 300 also includes a processing unit 31 and a storage unit 32. In at least one embodiment, the processing unit 21 can be a central processing unit, a digital signal processor, or a single chip, for example. In at least one embodiment, the storage unit 22 can be an internal storage system, such as a flash memory, a random access memory (RAM) for temporary storage of information, and/or a read-only memory (ROM) for permanent storage of information. In at least one embodiment, the VM 300 is constituted in a computing device (not shown), such as a server, a personal computer, and the like. The storage unit 32 can be a storage space assigned from a storage device, such as a hard disk, of the computing device. The processing unit 31 can be one of processing chips, such as one of centre processing units of the computing device.

The installation system 1 includes a management module 10 at least one communication module 20, and at least one couldboot system 30. Each communication module 20 is associated with one corresponding couldboot system 30.

In at least one embodiment, the management module 10 can be collections of software instructions stored in the storage unit 22 of the server 2 and executed by the processing unit 21 of the server 2. The cloudboot system 30 can be collections of software instructions stored in the storage unit 32 of the VM 300 and executed by the processing unit 31. In at least one embodiment, the communication module 20 can be a program stored in the storage unit 32 of the VM 300. For example, the communication module 20 can be a remote procedure call (RPC) box, which functions as a email program. In another embodiment, the communication module 20 associated with the cloudboot system 30 can be a communication chip set in the computing device including the corresponding VM 300.

In at least one embodiment, the cloudboot system 30 is compatible with a number of virtual platforms. The cloudboot system 30 includes various virtual driver files respectively corresponding to various virtual platforms. If the VM 300 already have stored and installed the cloudboot system 30, when the VM 300 is started up, the cloudboot system is run firstly. When the cloudboot system 14 is running, the cloudboot system 14 determines a virtual platform which can support the VM 100, and determines a virtual driver file corresponding to the determined virtual platform, and then starts up the guest operating system 12 stored in the storage unit 20 according to the determined virtual driver file. In at least one embodiment, the cloudboot system 14 first loads the virtual driver file, and starts up the guest operating system according to the loaded the virtual driver file. Therefore, utilizing the cloudboot system 14 of the present disclosure, the VM 100 can be started up by another virtual platform by using the corresponding virtual driver file.

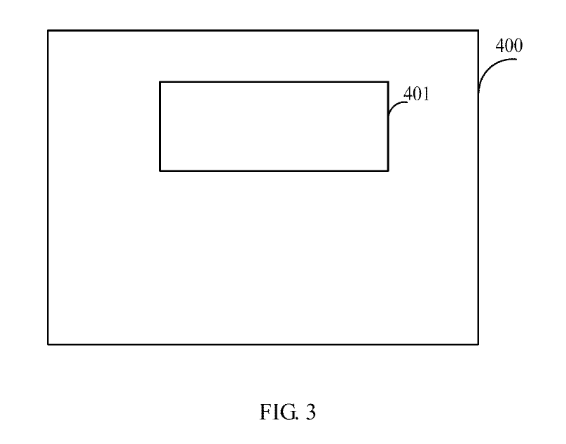

Referring to FIG. 3, the management module 10 is used to provide a management interface 400 provided for a user to input or select a command for the VM 300, and transmit the command input or selected by the user to the communication module 20 associated with the VM 300. In at least one embodiment, the management interface 400 includes at least one selection box 401 provided to input or select the command. The command input or selected by the user can include a startup command to start up the VM 300, a download command to download an installation file of one corresponding guest operating system 12 to the VM 300, and the like. The startup command includes information of the VM 300 to be started up, such as a name of the VM 300, a network address of the VM 300. The download command includes information of the installation file corresponding the guest operating system 12, such as a name of the installation file.

When the communication module 20 receives the startup command, the VM 300 and the corresponding cloudboot system 30 of the VM 300 is started up. In at least one embodiment, the VM can be trigged to start up upon the startup command received by the communication module 20. When the cloudboot system 30 is running, if the communication module 20 further receives the download command, the cloudboot system 30 downloads the installation file from the server 200 and executes the installation file to install the guest operating system 12 corresponding to the installation file on the VM 300.

According to the present disclosure, the guest operating system 12 can be installed in the VM 300 based on various virtual platforms due to the cloudboot system 300 includes various virtual driver files respectively corresponding to various virtual platforms.

In at least one embodiment, the storage unit 32 of the VM 300 is divided into at least a first partition 16 and a second partition 18 at least. The cloudboot system 30 is stored and installed in the first partition 16. The cloudboot system 30 executes the installation file to install the guest operating system 12 corresponding to the installation file on the second partition 18 of the VM 300.

In at least one embodiment, the storage unit 32 of the VM 300 divided into at least the first partition 16 and the second partition 18 when installing the cloudboot system 30 on the VM 300. The related technology of installing the cloudboot system 30 on the VM 300 are disclosed in a related patent applications whose attorney docket No. is US54180.

In at least one embodiment, a size of the first partition 16 can be 200 megabits.

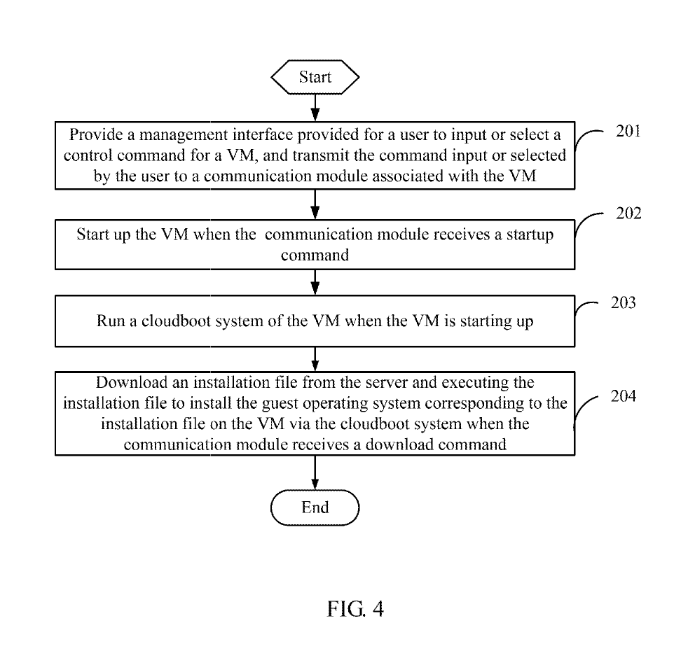

FIG. 4 illustrates a flowchart of a method for starting up a VM. The method is provided by way of example, as there are a variety of ways to carry out the method. The method described below can be carried out using the configurations illustrated in FIG. 1, for example, and various elements of these figures are referenced in explaining the example method. Each block shown in FIG. 4 represents one or more processes, methods, or subroutines carried out in the example method. Additionally, the illustrated order of blocks is by example only and the order of the blocks can be changed. The example method can begin at block 201.

In block 201, a management module provides a management interface provided for a user to input or select a command for a VM, and transmit the command input or selected by the user to a communication module associated with the VM.

In block 202, the VM is started up when the communication module receives a startup command.

In block 203, a corresponding cloudboot system of the VM is running when the VM is starting up.

In block 204, the cloudboot system downloads an installation file from the server and executes the installation file to install the guest operating system corresponding to the installation file on the VM when the communication module further receives the download command.

In at least one embodiment, the method further includes: the cloudboot system determines a virtual platform supporting the VM, and determines a virtual driver file corresponding to the determined virtual platform, and loads the virtual driver file, and then starts up the guest operating system according to the loaded virtual driver file.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An installation system for installing a guest operating system on a virtual machine (VM) comprising:
a communication module;
a cloudboot system comprising collections of software instructions stored in a storage unit of the VM and executed by a processing unit of the VM; and
a management module comprising collections of software instructions stored in a storage unit of a server and executed by a processing unit of the server, when being executed by the processing unit of the server, the management module causes the processing unit of the server to provide a management interface provided for a user to input or select a command for the VM, and transmit the command input or selected by the user to the communication module;
wherein when the communication module receives a startup command, the cloudboot system is started up; when the communication module receives a download command while the cloudboot system has been started up, the cloudboot system downloads an installation file from the server and execute the installation file to install a guest operating system corresponding to the installation file on the VM.

2. The installation system according to claim 1, wherein the cloudboot system further comprise various virtual driver files respectively corresponding to various virtual platform, the cloudboot system is further configured to determine a virtual platform supporting the VM, and determine a virtual driver file corresponding to the determined virtual platform, and start up the guest operating system installed on the VM according to the virtual driver file.

3. The installation system according to claim 1, wherein the cloudboot system is preinstalled in a first partition of the storage unit of the VM, and the cloudboot system execute the installation file to install the guest operating system on a second partition of the storage unit of the VM.

4. The installation system according to claim 3, wherein a size of the first partition of the storage unit of the VM is 200 megabits.

5. The installation system according to claim 1, wherein the communication unit is a remote procedure call box stored in the storage unit of the VM and executed by the processing unit of the VM.

6. A method for installing a guest operating system on a virtual machine (VM) comprising:
providing a management interface provided for a user to input or select a command for a VM, and transmitting the command input or selected by the user to a communication module;
starting up the VM when the communication module receives a startup command;
running a cloudboot system of the VM when the VM is starting up; and
downloading an installation file from the server and executing the installation file to install the guest operating system corresponding to the installation file on the VM via the cloudboot system when the communication module receives a download command.

7. The method according to claim 6, further comprising:
determining a virtual platform supporting the VM and determining a virtual driver file corresponding to the determined virtual platform;
loading the virtual driver file; and
starting up the guest operating system installed on the VM according to the loaded virtual driver file.
